(19) United States
(12) Patent Application Publication
(10) Pub. No.: US 2013/0258643 A1
(43) Pub. Date: Oct. 3, 2013

(54) OPTICAL PANEL DISPLAY

(71) Applicants: Robert P. Helstern, Irvine, CA (US); Lan-Chi Truong, Westminster, CA (US)

(72) Inventors: Robert P. Helstern, Irvine, CA (US); Lan-Chi Truong, Westminster, CA (US)

(21) Appl. No.: 13/904,301

(22) Filed: May 29, 2013

Related U.S. Application Data
(63) Continuation-in-part of application No. 12/839,312, filed on Jul. 19, 2010.
(60) Provisional application No. 61/704,367, filed on Sep. 21, 2012.

(51) Int. Cl. G09F 13/04

(52) U.S. Cl. CPC G09F 13/04
USPC 362/97.1; 445/24

(57) ABSTRACT

An optical panel display with one or more signal zones selectively illuminated by a light source such as a light emitting diode light source.

### INCORPORATION BY REFERENCE

This application is a continuation-in-part of U.S. patent application Ser. No. 12/839,312 filed Jul. 19, 2010. This application incorporates by reference U.S. patent application Ser. No. 12/839,312 in its entirety and for all purposes, such incorporation including in particular FIGS. 1-7 together with corresponding portions of the patent application disclosure.

This application claims the benefit of U.S. Prov. App. No. 61/704,367 filed Sep. 21, 2012. This application incorporates by reference U.S. Prov. App. No. 61/704,367 in its entirety and for all purposes, such incorporation including in particular FIGS. 1-6 together with corresponding portions of the patent application disclosure, and Attachments 1-3.

### BACKGROUND OF THE INVENTION

1. Field of the Invention

The present invention relates to optical devices. In particular, display optics alter the characteristics of light passing therethrough for the purpose of illuminating a panel display.

2. Discussion of the Related Art

Illuminated visual displays are ubiquitous. They are found in old devices such as candle boxes with sidewall cutouts and in modern devices such as electrically lighted signage. These devices are adapted to convey a message to a viewer, usually via a brightly lit message that appears amid relatively dark surroundings.

Although illuminated displays are commonplace, new applications frequently demand technological advancements including, for example, improved light sources, optics and packaging. Advancements in displays for use in bright sunlight, that is sunlight readable displays, are one example. Other less well known examples include advanced low profile displays and displays for use in concert with night vision equipment.

### SUMMARY OF THE INVENTION

A display panel has one or more signal zones. In an embodiment, a method for constructing a thin profile display with discrete signal zones, the method comprising the steps of: providing a chassis with light impenetrable tunnels; affixing a plurality of light sources to a substrate sealing an end of the light tunnels, the light sources illuminating the light tunnels; covering opposed ends of the light tunnels with a refractor sheet not more than 1 mm thick; providing an indicia layer including an indicia layer substrate not more than 0.5 mm thick; coarse graining a viewable surface of the indicia layer substrate to measure 2-3 gloss units; fine graining a light receiving surface of the indicia layer substrate to measure 4-6 gloss units; forming indicia on the fine grained surface of the indicia layer substrate; providing for uniformly illuminated indicia by diffusing light emitted from the light sources as it passes through the refractor and the indicia layer; and, providing for decoupled signal zones by utilizing a thin refractor and a thin indicia layer.

As persons skilled in the art will understand, particular gloss values can be achieved by treating surfaces with coatings and/or deformations that vary the gloss. Achievement of a desired gloss specification can be tested for various treatments and confirmed using a gloss meter such as the one provided by Paul N. Gardner Company, Inc., 316 N.E. First Street, Pompano Beach, Fla. 33060. Recognized test methods, for confirming a desired gloss value is achieved, include the ASTM D525 standard for gloss measurement.

The above embodiment further comprising: providing an optical monolith operable to pass visible light only; and, inserting the optical monolith in the light tunnel such that near infrared wavelengths are removed from light emitted by the light source that is incident on the refractor.

In an embodiment, a display having a panel-like profile, the display comprising: a lighting assembly including a chassis with discrete apertures and the chassis located between a light source circuit board and an inner light diffusing layer; an indicia layer lighted by the lighting assembly; the indicia layer including a second set of apertures; and, the apertures located between an indicia layer substrate and the lighting assembly.

Some embodiments of the invention share one or more of the features itemized in the table below.

| | SIGNAL | |
|---|---|---|
| ELEMENT | ZONE | CONSTRUCTION |
| Face Plate | Shines through | Cell cast acrylic |
| Quasi | emission spaces | Thickness: 14 to 20 1/1000 inch (<½ mm) |
| discrete | | Cross talk is minimized due to attenuated coupling due to thin |
| signal zones | | cross section; some margin between signal zones |
| Paint can | | How to make |
| match chassis | | 1. pour monomer into cell w/ pattern finish on cell outer |
| color | | surface . . . like a grain |
| | | 2. outer grain gives 2-3 gloss units viewable |
| | | surface/touchable surface/outermost surface |
| | | 3. transparent part |
| | | 4. innermost side has 2^{nd} grain w/ gloss of 4-6 gloss units; |
| | | finer than 1^{st} side . . . creates parallax when light |
| | | traverses . . . expands image even further |
| | | 5. attach thin opaqueing paint that adheres to fine gran |
| | | inner surface |
| | | 6. after paint application, use laser to evaporate paint to |
| | | reveal the desired indicia |
| | | Other |
| | | 1. grainy surface uses parallax to misshape rays preventing |
| | | them from going straight through |
| | | 2. eye tends to exaggerate intensity of shine-through . . . |
| | | grainy diffuser softens light reaching the eye and |
| | | improves readability |
| | | 3. to straight light rays shining thru indicia may cause |
| | | misreading . . . points of light misrepresent the |
| | | continuous figure they are intended to illuminate |
| | | 4. object is to create signal zone with everywhere the same |
| | | light intensity . . . homogeneous light intensity |
| | | 5. most LED light is w/ 10-15 degree angle of the light |
| | | center line (“LCL”) typically not good for indicia |
| | | illumination |
| | | 6. sunlight readable levels of brightness from LED's |
| | | enable: change character in day light; annunciate a |
| | | hidden symbol in direct sunlight; contrast generated by |
| | | bright light . . . 2-3 gloss on outside surface . . . luminance |
| | | contrast reveals symbol or message |
| | | 7. note embodiments of this invention utilizes LED in |
| | | compact format . . . normally, a diffuse incandescent |
| | | source in required in compact format applications but it |
| | | evolves too much heat when intensity is large enough |
| | | for SLR application |
| Inner (Ti) | Cannot | Cell cast acrylic |
| Layer | distinguish/ | Comments |
| Homogeneous | homogeneous | 1. liquid inclusions that become part of solid matrix after |
| diffusion | | polymerization |
| layer, no | | 2. works the way a magnifying lens works . . . diffuses light |
| discretization | | 3. expands image to accommodate larger image sizes |
| into distinct | | 4. artificially expands profile of light coming out of the |
| signal zones | | chassis hole |
| | | 5. prevents chassis from being larger than face plate |
| | | 6. expanded light profile provides for a chassis material |
| | | periphery for mounting features which enable near |
| | | identical aspect dimensions of chassis and face plate |
| | | 7. without Ti/O2, might use conical hole . . . but this is |
| | | difficult to manufacture . . . conical hole acts as diffuser |
| | | but mechanical strength is again compromised |
| | | 8. enables rectangular presentation of the face plate to be |
| | | kept small |
| Chassis | Cut-outs expose | Cell cast acrylic |
| Discrete | lenses | Loaded with optically dense inclusions to prevent internal light |
| signal zones | | transmission |
| w/ protection | | Optional Lenses Mounted In Cut-Outs |
| against cross | | 1. wavelength trimming function for example |
| talk | | 2. take out IR |
| | | 3. produce particular hue of light |
| | | 4. different colors |
| | | 5. not a film . . . like a monolith with or without inclusions |
| | | 6. provide for operation in a night vision environment |
| Circuit Board | Lights adjacent | Light is blocked from escaping through PCB as PCB |
| | to cut-outs | constructed with opaque epoxy/glass material. Cross talk |
| | | minimized by chassis curtain walls. |

Some optical display panels include an optical monolith for enhancing the diffusion of light comprising: a monolith including an optical plastic; the monolith operable to transmit light incident on one monolith surface to and through a second monolith surface, a monolith thickness being defined by a spacing between the first and second monolith surfaces; polymeric inclusions distributed throughout the optical plastic for interrupting light rays refracted by the monolith; and, the polymeric inclusions selected to simultaneously a) absorb a particular portion of the visible spectrum of the incident light and b) diffuse refracted rays of the incident light.

In some embodiments the optical plastic, inclusions and thickness are chosen to provide a light transmissivity from about 22.5 percent to about 30 percent over a range of wavelengths from about 430 nanometers to at least about 780 nanometers. And, in some embodiments the inclusions are polystyrene particles having an average particle diameter from about 0.2 microns to about 20.0 microns and in some embodiments the inclusions are titanium dioxide particles having an average diameter from about 0.2 microns to about 20 microns.

In some embodiments the optical plastic liquid is an acrylic monomer and in some embodiments the optical inclusion liquid is a styrene dissolved in acrylic monomer. And, in some embodiments a homogenous solution of the optical plastic and inclusion liquids is enclosed in a pliable, transparent container.

In some embodiments the monolith including optical plastic and polymeric inclusions is formed by blending polymers; in an embodiment a first blended polymer is a polycarbonate based optical material; in an embodiment a second blended polymer is a silicon co-polymer based inclusion material; and, in an embodiment the optical plastic is a flowable material.

A method of making an optical device to diffuse light comprises the steps of: specifying the performance of an optical monolith by selecting the monolith's attenuation of selected wavelengths of light; selecting a monomer suited for making a plastic from the group consisting of polymethylmethacrylate, polystyrene, polycarbonate, acrylic styrene methyl methacrylate copolymer, polyolefin, arton, Optores OZ 1000-1100, and Optores OZ 1310-1330; selecting an inclusion for distributing in the monomer, the inclusion's light absorbing and light reflecting properties being selected in accordance with the specified monolith performance and a monolith thickness; mixing the monomer and the inclusion; filtering the mixture to control a dimension of the inclusions; adding a hardener for polymerizing the monomer to the mixture; and, filling a mold with the mixture for casting the optical monolith.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1 shows a display in accordance with the present invention.

FIG. 2 shows an embodiment of the display of FIG. 1.

FIG. 3 shows an embodiment of the display of FIG. 1.

FIG. 4 shows a display embodiment similar to that of FIG. 3.

FIG. 5 shows a cross-section of a simplified display with features similar to those of the display of FIG. 4.

FIG. 6 shows an assembled view of the display of FIG. 5.

FIG. 7 shows another display similar to that of FIG. 4.

### DETAILED DESCRIPTION OF PREFERRED EMBODIMENTS

The disclosure provided in the following pages describes examples of some embodiments of the invention. The designs, figures and description are non-limiting examples of the embodiments they disclose. For example, other embodiments of the disclosed device and/or method may or may not include the features described herein. Moreover, disclosed advantages and benefits may apply to only certain embodiments of the invention and should not be used to limit the disclosed invention.

As used herein, the term “coupled” includes direct and indirect connections. Moreover, where first and second devices are coupled, intervening devices including active devices may be located therebetween.

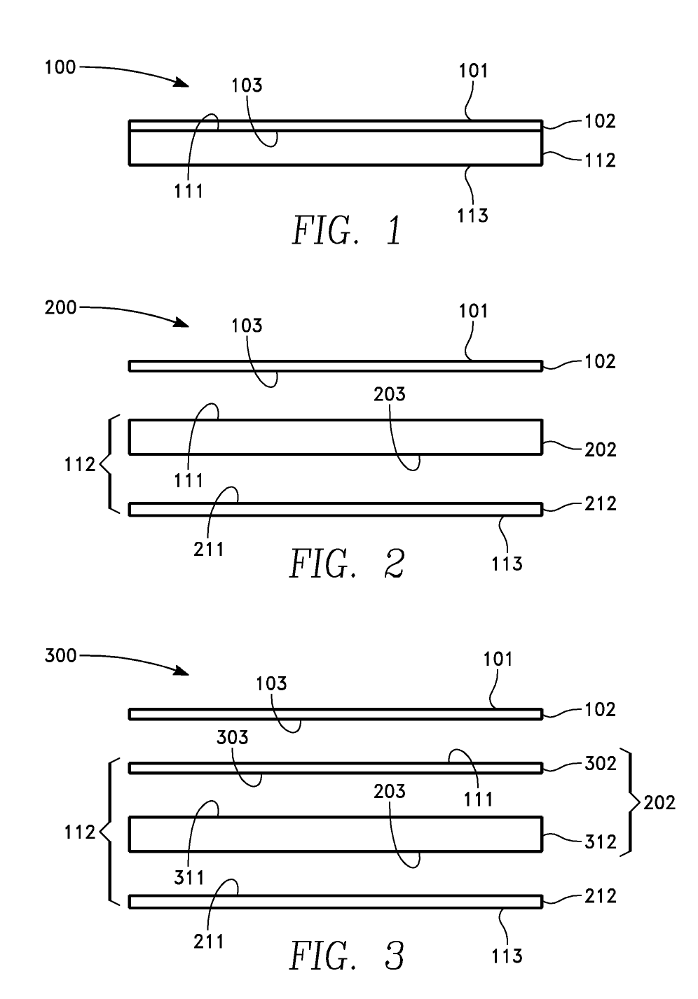

FIG. 1 shows a display 100. The display includes a lighting assembly 112 adjacent to an indicia layer 102. In some embodiments, the indicia layer may be referred to as a face plate. The indicia layer includes a viewable surface 101 and a light receiving surface 103. The lighting assembly includes a back surface 113 and a light emitter surface 111 that is adjacent to the light receiving surface.

FIG. 2 shows an embodiment of the multielement display including three elements 200. As above, an indicia layer 102 is adjacent to a lighting assembly 112. Here, the lighting assembly includes a light source 212 and a projector section 202. The light emitting face of the projector section 111 is adjacent to the light receiving face of the indicia layer 103 and a light receiving face of the projector 203 section is adjacent to the light source. In particular, the light source 212 of the lighting assembly 112 has a light emitting surface 211 and a back surface 113.

FIG. 3 shows an embodiment of the multielement display including four elements 300. As above, an indicia layer 102 is adjacent to a lighting assembly 112 which includes a projector section 202 and a light source 212. Here, the projector section 202 includes chassis 312 with a light receiving face 203 adjacent to the light source emitting face 212. A chassis light emitting face 311 is adjacent to a light refractor 302. In particular, the light refractor has a light receiving face 303 adjacent the light emitting face of the chassis and a light emitting face 111 adjacent the indicia layer's light receiving face 103. In some embodiments, the light refractor 302 may be omitted and in some embodiments the refractor 302 may be in the form of a coating, such as a TiO2 coating applied to the indicia layer.

As persons of ordinary skill in the art will appreciate, embodiments of the described panel display provide an indicial layer 102 lighted by a lighting assembly 112 to selectively display one or more visually perceivable messages such as textural or symbolic messages including hidden messages discussed below. As further described herein, embodiments provide, inter alia, selected message intensities, colors, wavebands, and illumination duty cycles.

Some embodiments of the displays of FIGS. 1-3 are compliant with the military specification MIL-DTL-7788G. And, some embodiments of the displays of FIG. 1-3 have an overall thickness of 0.240 inches plus or minus 0.023 inches. For example, an embodiment of the display of FIG. 3 has approximate thicknesses of: indicia layer substrate 0.020 inches and indicia layer flood coat 0.004 inches (e.g., indicia layer 102); refractor 0.018 inches (e.g., refractor 302); chassis/structural 0.170 inches (e.g., chassis 312); light plate/printed circuit board 0.030 inches (e.g., light source 212); and, other optional layer(s) such as adhesive 0.005 inches. In various embodiments, any of these dimensions may vary in order to obtain an overall thickness of 0.240 inches plus or minus 0.023 inches. And, in various embodiments, any of these dimensions may vary by as much as 9% in order to obtain an overall thickness of 0.240 inches plus or minus 0.023 inches.

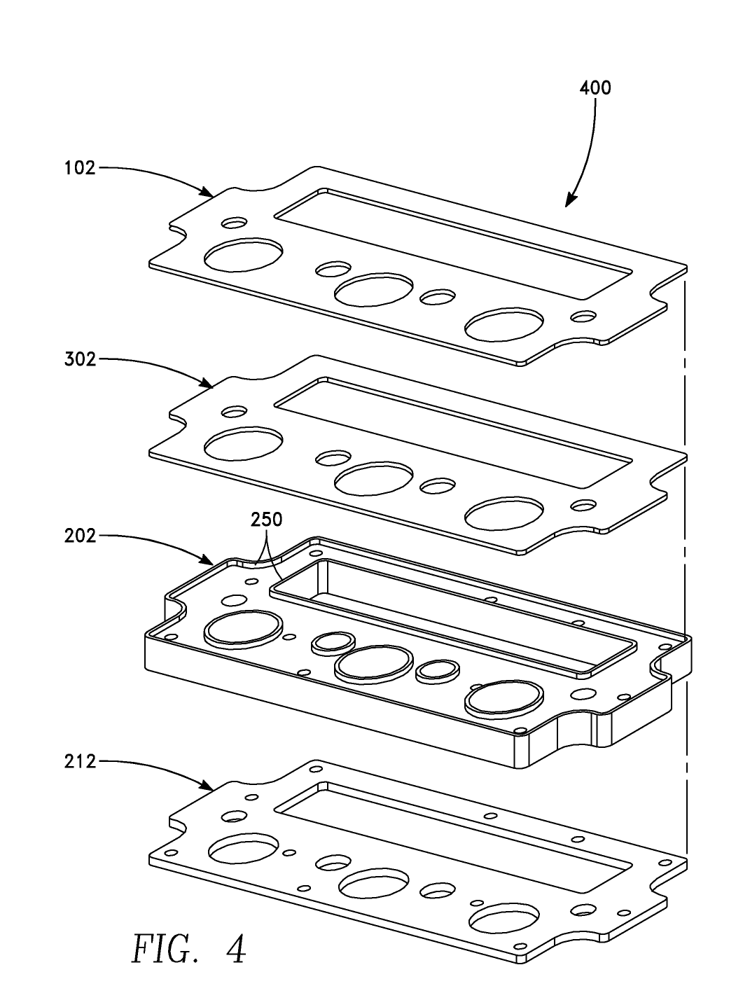

FIG. 4 illustrates a particular four element embodiment of the display panel 400. This embodiment is configured to provide a front panel display for a particular aircraft control panel device. Notably, uses of the present invention are not limited to aircraft control panels nor are they limited to aeronautical uses. To the contrary, any number of devices such as portable displays like a wrist watch display and aircraft mounted displays such as ordinance displays can benefit from embodiments of the present invention.

In FIG. 4, a chassis 202 lies between a circuit board with lights such as an LED light source 212 and a titanium dioxide based light refractor 302. Mounted atop the refractor is an indicia layer, or portion thereof, in the form of a display face plate 102. Notably, the present invention is not limited to use of LED light sources but in embodiments uses other suitable light sources selected from the group of electroluminescent, fluorescent, gas discharge, incandescent, and other light sources known to persons of ordinary skill of the art.

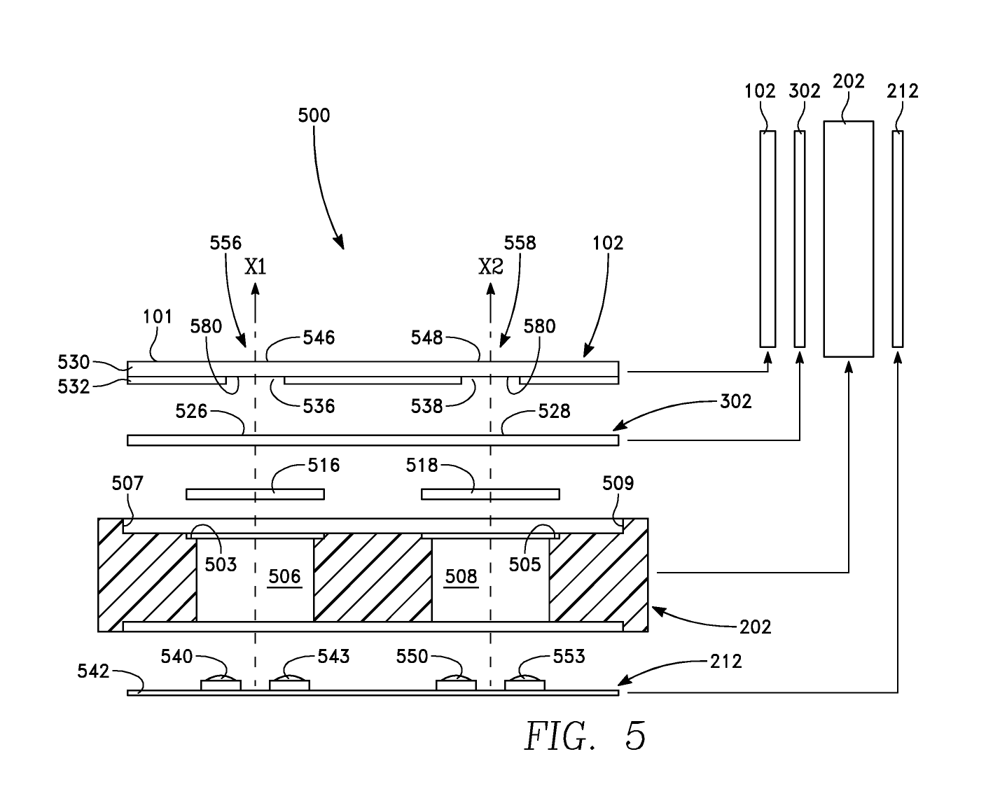

FIG. 5 shows an exploded cross-section of a simplified display, similar to the display of FIG. 4, 500. An end view is shown alongside the exploded cross-section. As seen, the light source 212 illuminates an indicia layer 102 via a chassis 202 and a refractor 302. Various details and embodiments are described below.

Multiple elements of the display panel implement light processing features and define a plurality of signal zones. For example, light paths indicated by axes X1 and X2 pass through signal zones defined by the elements.

Axis X1 extends between LED's 540, 543 to a viewable location 556 beyond the indicia layer 102. Light emitted by the LED's is contained by a first chassis light tunnel 506 and by an LED substrate 542. Light emitted from the first light tunnel is directed toward the refractor 302. In some embodiments, a lens 516 is interposed between the refractor and the chassis. For example, embodiments of the lens include optical light processors that vary intensity, color, and wavelengths. In some embodiments, the lens is like one of the optical monoliths of applicant's U.S. Pat. Pub. No. 2012/0013986 A1 which is incorporated herein by reference, in its entirety and for all purposes. In some embodiments, a lens is fitted onto a first inner shoulder 503 of the chassis and in some embodiments the refractor is fitted onto a first outer shoulder 507 of the chassis. As discussed herein, luminous devices other than light emitting diodes may be used.

Light passing through the refractor 302 and in particular through a zone of the refractor 526 adjacent to the light tunnel 506 impinges on the indicia layer 102. As shown here, the indicia layer includes a light blocking coating such as an opaque paint 532. The coating is applied and/or removed in a manner that reveals indicia 536 that will appear on and/or through the viewable surface 101 and in particular on and/or through a portion of the viewable surface 546 opposite the indicia. As shown, an indicia layer substrate 530 provides a light transmitting means to which the coating is adhered.

Axis X2 extends between LED's 550, 553 to a viewable location 558 beyond the indicia layer 102. Light emitted by the LED's is contained by a second chassis light tunnel 508 and by an LED substrate 542. Light emitted from the first light tunnel is directed toward the refractor 302. In some embodiments, a lens 518 similar to lens 516 is interposed in between the refractor and the chassis. In some embodiments, the lens is fitted onto a first inner shoulder 505 of the chassis and in some embodiments the refractor is fitted onto a first outer shoulder 509 of the chassis. As discussed herein, luminous devices other than light emitting diodes may be used.

Light passing through the refractor 302 and in particular through a zone of the refractor 528 adjacent to the light tunnel 506 impinges on the indicia layer 102. As shown here, the indicia layer includes a light blocking coating such as an opaque paint 532. The coating is applied and/or removed in a manner that reveals indicia 538 that will appear on and/or through the viewable surface 101 and in particular on and/or through a portion of the viewable surface 548 opposite the indicia. As shown, an indicia layer substrate 530 provides a light transmitting means to which the coating is adhered.

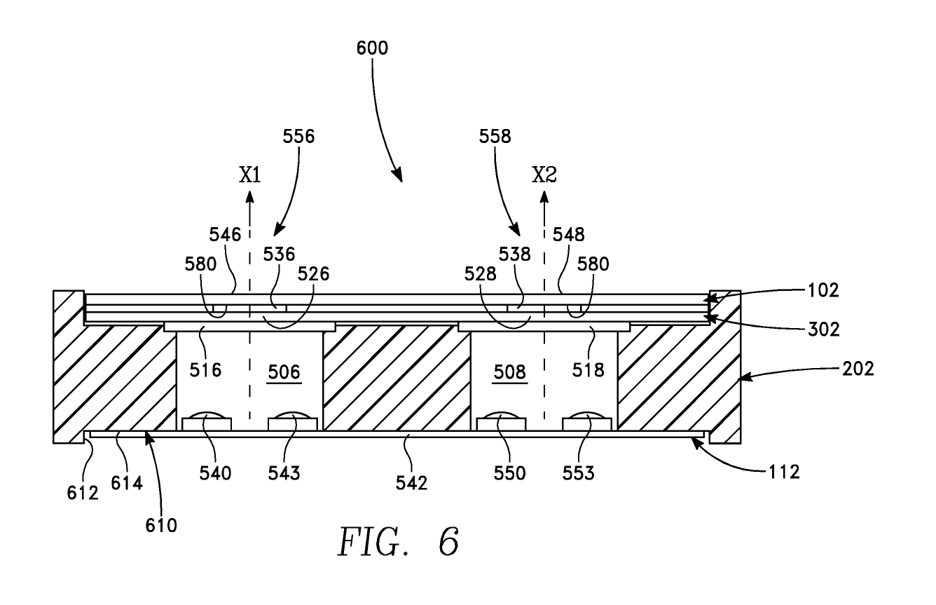

FIG. 6 shows an illustrative cross-sectional view of a four element display, similar to that of FIG. 5, 600. Among other things, the assembled display panel 600 provides multiple signal zones such as the signal zones along axes X1 and X2. In various embodiments, the signal zones transmit, process, and/or direct light.

The chassis forms a part of the signal zones along axes X1 and X2. In various embodiments, the chassis 202 is made from opaque material as is the light source substrate 542 such that light is contained both due to the opaque material and also due to seal(s) 610 between light source substrate and the chassis. Such seals may include shoulders 612, 614 as shown in FIG. 6, and/or such seals may include curtain walls 250 around cut-outs as shown in the chassis 202 of FIG. 4.

To the extent a lens 516, 518 is included, this portion of the signal zone processes the light as described above. Light leaving the lens is transmitted through the refractor 302. Here, the light front is expanded by the diffusing characteristics of the refractor. Typical refractor construction is an acrylic material such as a cell cast acrylic in a homogeneous mixture with light dispersing inclusions. In some embodiments, the refractor includes liquid inclusions that become part of a solid matrix after polymerization of an included plastic such as methyl methacrylate or poly methyl methacrylate (“PMMA”). In some embodiments, solid inclusions such as titanium dioxide particles are used. In some embodiments, the refractor thickness (“rt”) range is about 2 mm>=rt>0.5 mm and in some embodiments with reduced cross coupling, the refractor thickness range is about 0.1 mm<=rt<=0.5 mm. Notably, the refractor's expanded light profile provides for similar chassis and indicia layer dimensions while providing sufficient chassis peripheral material for mounting features. Otherwise larger chassis aspect dimensions are avoided which enables near identical aspect dimensions of the chassis and the indicia layer.

Light leaving the refractor transmission zones 526, 528 shines through the indicia 536, 538 of the indicia layer 102. An embodiment of the indicia layer provides a transparent cell cast acrylic sheet 530 of FIG. 5. In some embodiments, the indicial layer thickness (“ilt”) range is about 2 mm>=ilt>0.5 mm and in some embodiments with reduced cross coupling, the indicia layer thickness is about 0.1 mm<=ilt<=0.5 mm. In some embodiments, a translucent sheet is used. An inside surface of the substrate is treated to reveal an indicia 536, 538 such as by adhering and/or removing an opaque coating. For example, indicia may be revealed by laser evaporation of portions of an adhered coating.

Embodiments of the substrate have grainy surfaces. For example, a substrate embodiment provides a grain of 2-3 gloss units on the viewable surface 101 of FIG. 1 and a grain of 4-6 gloss units on the light receiving surface 580. These grains and grain variations provide a parallax means for further diffusing/expanding the light profile reaching the viewable surface. It also serves to soften the light, to spread the light rays, and to present indicia having uniform intensity.

As seen, the signal zones indicated by axes X1, X2 provide viewable indicia 556, 558 that are discrete and optically de-coupled. In various embodiments of the present invention, optical de-coupling enables a display panel to transmit a somewhat arbitrary number of discrete signals, each signal being conveyed in a respective signal zone.

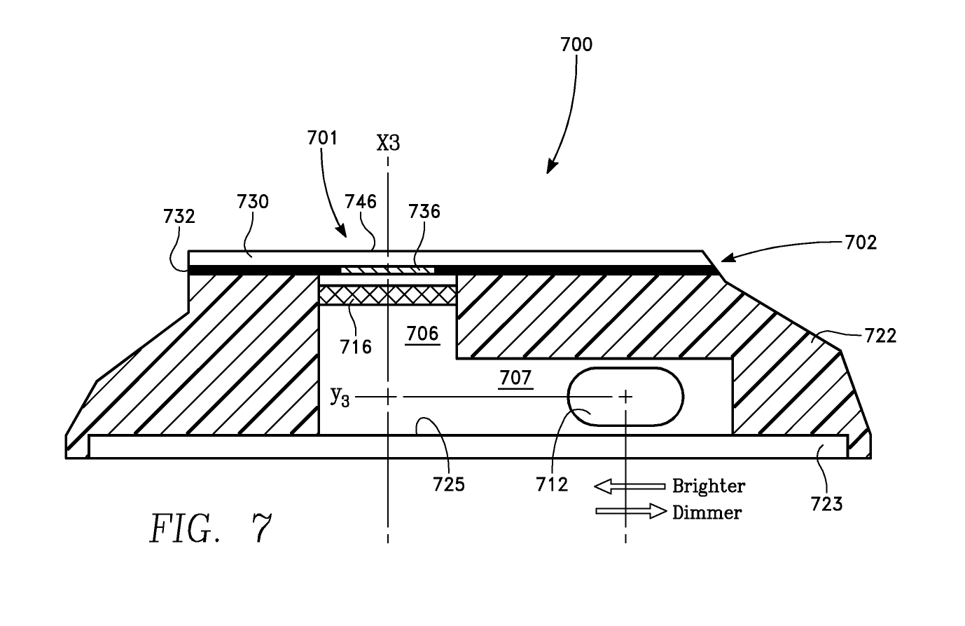

FIG. 7 shows an illustrative cross-sectional, exploded view and perspective view of display similar to the display of FIG. 5 700. As seen, a light source 712 illuminates an indicia layer or face plate 702 via light passages 706, 707 in a chassis 722. While the light source may be any suitable light source including any suitable light emitter, this description refers to light emitting diodes as a frequent choice. In some embodiments, a refractor (not shown) is interposed between the light source and the indicia layer. Various details and embodiments are described below.

The display panel implements light processing features and defines one or more signal zones (one shown). For example, the light path indicated by axis X3 passes through a signal zone defined by element(s) of the display.

In FIG. 7, axis X3 is about perpendicular to a floor 723 of the display. The axis X3 is about centered in an indicia light tunnel 706 that extends through the chassis 722. Along the axis X3 is a viewable surface such as a free surface 746 that is opposite indicia 736 carried by the indicia substrate 730. In an embodiment, a coating such as one mentioned above is applied to the substrate and then selectively removed to form indicia. An optional optical element 716 processes light before it reaches the indicia layer 702. For example, embodiments of the optical element include optical light processors that vary intensity, color, and wavelengths. In some embodiments, the optical element is like one of the optical monoliths of applicant's U.S. Pat. Pub. No. 2012/0013986 A1.

Intersecting the indicia light tunnel 706 is a light emitter chamber 707 extending along an axis Y3 that is about perpendicular to the X3 axis. A movable light emitter 712, such as a light emitting diode and carriage, is located in the chamber. From an initial position remote from the viewable surface 746, movement of an operating light emitter toward the X3 axis increases the intensity of light leaving the tunnel and striking the indicia 736.

Light emitted by the light source 712 is initially contained in the light emitter chamber 707 which is bounded at least in part by the display floor 723 and the chassis 722. Light leaving the chamber enters the indicia light tunnel 706 and is again contained by the chassis and/or the display floor. Embodiments with reflective portions can be used to direct the light. For example, an embodiment with a reflective floor or reflective floor portion 725 can be configured to preferentially direct the light toward the indicia 736.

Light leaving the indicia light tunnel 706 subsequently impinges on the indicia 736. As indicated, the indicia layer 702 selectively blocks light to display the indicia 736. In some embodiments, an indicia symbol(s) is bright while a corresponding symbol background(s) is dark. And, in some embodiments, an indicia layer symbol(s) is dark while a corresponding symbol background(s) is bright. In each case, luminous contrast provides for readability when the indicia is illuminated by a light source 712.

For blocking light transmission through the face plate, a light blocking coating 732 such as an opaque coating or paint may be used. In various embodiments, the coating is applied and/or removed to reveal indicia 736 that will appear on and/or through the viewable surface 701 and in particular on and/or through a portion of the viewable surface opposite the indicia. As shown, an indicia layer substrate 730 provides a light transmitting means to which the light blocking coating, for example a flood coating, is adhered.

Embodiments of the present invention provide a compact light panel with a thin profile and occupying less facial area than long used technologies. Incandescent light sources with old, thin panel designs have made some benefits and desirable features, such as sunlight readable displays, more difficult to achieve due to the heat produced by incandescent light(s) operated at required intensities. Moreover, old designs with relatively thick transparent panels more easily couple light between indicia and have not generally accommodated discrete signal zones in the same display panel.

In various embodiments, LED's solve the light intensity and heat problem while optically decoupled media in the signal zone provide substantially homogeneous light intensity throughout indicia presented to viewers. Some embodiments of the present invention meet the requirements of MIL-DTL-7788G, dated 15 Oct. 2010 and MIL-PRF-22885.

LEDs have also led to problems. While LEDs largely solve the heat evolution problem, they present another problem, the need for a thick panel profile that provides for spreading the highly colluminated light rays emitted by an LED light.

Embodiments of the present invention utilize an LED light source emitting light that is contained in light-tight tunnels and transmitted through thin optical decoupling media including an optional refractor and a face plate. Lens or optical elements such as monolith lens provide added features including management of intensity, color, and wavelengths; for example, wavelength trimming, removal of near IR, and night vision environment operation.

Embodiments of the present invention offer sunlight readability and use of “dead fronts” having indicia apparent only when illumination is active. Typically, light emitting assemblies 112 illuminating hidden indicia will not include a refractory layer 302. Such hidden indicia include indicia indistinguishable to the human eye due to lack of color and luminous contrast, even under direct brilliant sunlight. These hidden indicia become visible only when they are illuminated.

While various embodiments of the present invention have been described above, it should be understood that they have been presented by way of example only, and not limitation. It will be understood by those skilled in the art that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for constructing a thin profile display with discrete signal zones, the method comprising the steps of:
providing a chassis with light impenetrable tunnels;
affixing a plurality of light sources to a substrate sealing an end of the light tunnels, the light sources illuminating the light tunnels;
covering opposed ends of the light tunnels with a refractor sheet not more than 1 mm thick;
providing a face plate including a face plate substrate;
coarse graining a viewable surface of the face plate substrate to measure 2-3 gloss units;
fine graining a light receiving surface of the face plate substrate to measure 4-6 gloss units;
forming indicia on the fine grained surface of the face plate substrate; and,
providing for uniformly illuminated indicia by diffusing light emitted from the light sources as it passes through the refractor and the face plate.

2. The method of claim 1 further comprising the step of decoupling adjacent signal zones by selecting suitably thin refractor and face plate thicknesses.

3. The method of claim 1 further comprising the step of selecting a face plate thickness of approximately 0.024 inches.

4. The method of claim 1 further comprising the step of selecting a combined face plate and refractor thickness of approximately 0.024 inches plus 0.018 inches.

5. The method of claim 1 further comprising:
providing an optical monolith operable to pass visible light only; and,
inserting the optical monolith in the light tunnel such that near infrared wavelengths are removed from light emitted by the light source that is incident on the refractor.

6. A display having a panel-like profile, the display comprising:
a lighting assembly including
a chassis with discrete apertures and
the chassis located between a light source and an inner light diffusing layer;
a face plate lighted by the lighting assembly;
the face plate including a second set of apertures; and,
the apertures located between a face plate substrate and the lighting assembly.

7. The display of claim 6 wherein:
the light source includes light emitting diodes.

8. A thin profile panel display comprising:
a face plate and a lighting assembly;
the face plate including an acrylic substrate with a viewable surface and an opposed non-viewable surface;
the viewable surface and the non-viewable surface bearing patterns formed during a cell casting process used to form the substrate;
the gloss of the non-viewable surface exceeding the gloss of the viewable surface;
indicia formed on the non-viewable surface where only portions of the non-viewable surface bear an opaque coating;
the lighting assembly including luminous device(s) for illuminating the indicia;
the face plate engages the lighting assembly to form the thin profile panel display with a thickness not exceeding 0.263 inches; and,
the lighting assembly for illuminating at least portions of the face plate.

9. The thin profile panel display of claim 8 further comprising:
an indicia light tunnel defining a longitudinal axis extending through the indicia;
a luminous device chamber defining a longitudinal axis extending through a light center line of the luminous device;
the longitudinal axes arranged to intersect to form an angle less than one hundred and eighty degrees; and,
the luminous device selectively movable along the chamber longitudinal axis for varying the illumination of the indicia.

10. The thin profile panel display of claim 9 wherein:
light emitted from the luminous device reaches the indicia only after it is reflected.

11. The thin profile panel display of claim 10 wherein the luminous device is operable to provide light emitted from a diode.

12. A method for constructing a thin profile, dead front display with discrete signal zones, the method comprising the steps of:
providing a chassis with light impenetrable tunnels;
affixing a plurality of light sources to a substrate sealing an end of the light tunnels, the light sources illuminating the light tunnels;
providing a face plate approximately 0.024 inches thick, the face plate including a face plate substrate;
coarse graining a viewable surface of the face plate substrate to measure 2-3 gloss units;
fine graining a light receiving surface of the face plate substrate to measure 4-6 gloss units;
forming indicia on the fine grained surface of the face plate substrate; and,
providing for uniformly illuminated indicia by diffusing light emitted from the light sources as it passes through the face plate.

13. The method of claim 12 further comprising the step of limiting the overall thickness of the display to not more than approximately 0.263 inches.
